(19) United States
(12) Patent Application Publication
(10) Pub. No.: US 2026/0204590 A1
(43) Pub. Date: Jul. 16, 2026

(54) ENERGY STORAGE DEVICE

(71) Applicant: TOYOTA JIDOSHA KABUSHIKI KAISHA, Toyota-shi (JP)

(72) Inventors: Shuichi NISHIDA, Toyota-shi (JP); Hiroyuki NAKAYAMA, Okazaki-shi (JP)

(73) Assignee: TOYOTA JIDOSHA KABUSHIKI KAISHA, Toyota-shi (JP)

(21) Appl. No.: 19/416,269

(22) Filed: Dec. 11, 2025

(30) Foreign Application Priority Data
Jan. 14, 2025 (JP) 2025-004996

(51) Int. Cl. H01M 4/72; H01M 4/66; H01M 10/0585

(52) U.S. Cl. CPC H01M 4/72; H01M 4/667; H01M 10/0585

(57) ABSTRACT

An energy storage device includes a battery module in which a stacked structure is housed and sealed within a laminate enclosure and the laminate enclosure is held between a pair of collector plates. The stacked structure includes cathode and anode layers disposed facing each other across a separator with a space between the cathode and anode layers filled with an electrolyte solution. Each collector plate includes a terminal. The terminals of the collector plates are electrically connected to the cathode and anode layers, respectively, and are electrically connected to the outside. The energy storage device further includes a battery pack that is an outer housing in which the battery module is installed on its bottom surface via an adhesive layer. The lower collector plate facing the adhesive layer has a through hole, and the adhesive layer includes a liquid reservoir configured to receive liquid passing through the through hole.

### CROSS-REFERENCE TO RELATED APPLICATION

This application claims priority to Japanese Patent Application No. 2025-004996 filed on January 14, 2025. The disclosure of the above-identified application, including the specification, drawings, and claims, is incorporated by reference herein in its entirety.

### BACKGROUND

### 1. Technical Field

The present disclosure relates to an energy storage device including a battery module, and more particularly, to a structure for addressing leakage of electrolyte solution from a battery module.

### 2. Description of Related Art

Energy storage devices having battery modules may be mounted on moving objects or portable equipment and carried around. Therefore, various configurations have been proposed to withstand impacts that may be encountered during movement. For example, Japanese Unexamined Patent Application Publication No. 2023-177537 (JP 2023-177537 A) proposes an energy storage device configured to suppress damage to an energy storage stack that may occur when the energy storage device is subjected to an external impact. The energy storage device includes: an energy storage stack including a plurality of energy storage modules arranged in a first direction; a pair of restraint plates sandwiching the energy storage stack in the first direction; a pair of side walls that faces each other in a second direction perpendicular to the first direction such that the energy storage stack is positioned therebetween; and a plurality of stoppers disposed between the energy storage stack and the pair of side walls on both outer sides of the energy storage stack in the second direction. Each of the restraint plates has an outer main surface on the opposite side from the energy storage stack. The outer main surface of each restraint plate is provided with a plurality of reinforcing portions extending in the second direction and arranged in a third direction perpendicular to the first and second directions. The stoppers are disposed at both ends of each reinforcing portion in the second direction, and each stopper is located at a position overlapping a corresponding one of the reinforcing portions in the first direction. Japanese Unexamined Patent Application Publication No. 11-73947 (JP 11-73947 A) provides a battery electrode having low electrical resistance while improving the adhesion between a current collector and an active material layer. It is proposed to form an adhesive layer in a dot, stripe, or grid pattern between the current collector and the active material layer by spraying or printing such that the adhesive layer covers 30% to 80% of the current collector surface that supports the active material layer. It is described that this configuration ensures sufficient adhesion, allowing smooth electron transfer between the current collector and the active material layer in the areas not coated with the adhesive, and maintaining low electrical resistance.

### SUMMARY

A battery module of a secondary battery such as a lithium-ion secondary battery is sometimes used as an energy storage element of an energy storage device. There are various types of such secondary battery modules. In a typical liquid-electrolyte battery module, a stacked structure is housed and sealed within an enclosure made of a laminate material (laminate enclosure). In the stacked structure, a cathode active material layer applied to a current collector foil (cathode foil), which may be a metal foil, and an anode active material layer applied to a current collector foil (anode foil), which may be a metal foil, face each other across a separator impregnated with electrolyte solution. In that case, a conductive region electrically connected to the cathode foil and a conductive region electrically connected to the anode foil are formed in regions of the enclosure that face the cathode foil and the anode foil, respectively. A cathode terminal and an anode terminal for external electrical connection are attached to respective collector plates, and the collector plates are bonded to the respective conductive regions. The battery module with the cathode and anode terminals attached thereto is disposed and housed within an outer housing (battery pack).

In an energy storage device in which a battery module as described above is housed in a battery pack, mechanical stress may be applied to the battery module due to insufficient mechanical strength of the battery pack or due to inertial forces. As a result, the laminate enclosure may tear and the electrolyte solution may leak out. If the cathode and anode terminals provided on the outside of the battery module become immersed in the electrolyte solution, an electrical short-circuit may occur. Accordingly, it is desirable to provide a configuration in which, even when electrolyte solution leaks from the battery module, the cathode and anode terminals provided on the outside of the battery module are not immersed in the electrolyte solution.

An object of the present disclosure is to provide, in an energy storage device in which a liquid-electrolyte battery module as described above is housed in a battery pack, a configuration that suppresses electrical short-circuiting at the cathode and anode terminals provided on the outside of the battery module, even when electrolyte solution leaks from the laminate enclosure of the battery module.

According to the present disclosure, the above object is achieved by an energy storage device including: a battery module in which a stacked structure is housed and sealed within a laminate enclosure and the laminate enclosure is held between a pair of collector plates, the stacked structure including a cathode layer and an anode layer disposed facing each other across a separator with the space between the cathode layer and the anode layer filled with an electrolyte solution, each of the collector plates including a terminal, and the terminals of the collector plates being electrically connected to the cathode layer and the anode layer, respectively, and electrically connected to the outside; and a battery pack that is an outer housing in which the battery module is installed on the bottom surface of the outer housing via an adhesive layer, wherein

a lower one of the collector plates of the battery module that faces the adhesive layer has a through hole, and the adhesive layer includes a liquid reservoir configured to receive liquid passing through the through hole.

In the above configuration, the "battery module" may typically be a module in which a liquid-electrolyte secondary battery such as a lithium-ion secondary battery is housed and sealed within a laminate enclosure. The secondary battery is, in a standard configuration, a stacked structure in which a cathode layer and an anode layer, formed by coating a cathode foil and an anode foil with a cathode active material layer and an anode active material layer, respectively, face each other across a separator, with the space between the cathode and anode layers filled with an electrolyte solution. Cathode and anode terminals electrically connected to the cathode and anode foils, respectively, are provided outside the laminate enclosure. The cathode foil, the cathode active material layer, the anode foil, the anode active material layer, the separator, and the electrolyte solution may be of types commonly used in the art. Typically, conductive regions are formed on surfaces of the laminate enclosure that face the cathode and anode foils, and a pair of collector plates, each provided with a terminal for external electrical connection, is bonded to both sides of the laminate enclosure so as to sandwich the laminate enclosure and make electrical connection to the conductive regions of the laminate enclosure. The battery module is then placed and fixed on the bottom surface of a battery pack, which is an outer housing, via an adhesive layer.

In the configuration of an energy storage device in which a battery module is disposed within a battery pack as described above, the present disclosure is configured as follows. The lower collector plate of the battery module facing the adhesive layer is formed with a through hole, and the adhesive layer includes a liquid reservoir configured to receive liquid passing through the through hole. With this configuration of the present disclosure, if the electrolyte solution leaks from the battery module for any reason, the electrolyte solution passes through the through hole of the lower collector plate and flows into the liquid reservoir formed in the adhesive layer. In this way, even when the electrolyte solution leaks from the battery module, contact of the terminals attached to the collector plates with the electrolyte solution is suppressed, and electrical short-circuiting between the terminals caused by the electrolyte solution is suppressed.

In the above configuration, the liquid reservoir in the adhesive layer may be a recess formed in any suitable manner and capable of receiving liquid from the through hole of the collector plate. Typically, the liquid reservoir may be formed by providing, in the adhesive layer, a region not coated with adhesive.

The arrangement of the through hole and the liquid reservoir may be determined in various ways. For example, since leakage of the electrolyte solution tends to occur at the four corners of the battery module, the through hole and the liquid reservoir may be provided below the four corners of the battery module. In the adhesive layer, the adhesive may be applied in a grid pattern or a strip pattern on the underside of the lower collector plate of the battery module, and regions not coated with the adhesive may serve as the liquid reservoirs.

With the configuration of the present disclosure, in an energy storage device in which a liquid-electrolyte battery module is housed in a battery pack, even when electrolyte solution leaks from the laminate enclosure of the battery module, the electrolyte solution passes through the through hole of the collector plate and is retained in the liquid reservoir of the adhesive layer. Accordingly, contact of the terminals with the electrolyte solution is suppressed, and electrical short-circuiting is suppressed. The configuration of the present disclosure is applicable to energy storage devices employing various liquid-electrolyte battery modules.

Other objects and advantages of the present disclosure will become apparent from the following description of preferred embodiments.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic sectional view illustrating one form of an energy storage device to which an embodiment is applied;

FIG. 1B is a schematic plan view of a lower collector plate in the energy storage device to which the embodiment is applied;

FIG. 1C is a schematic plan view of an adhesive layer in the energy storage device to which the embodiment is applied;

FIG. 2A is a schematic plan view illustrating another form of the lower collector plate in the energy storage device to which the embodiment is applied;

FIG. 2B is a schematic plan view illustrating another form of the adhesive layer in the energy storage device to which the embodiment is applied;

FIG. 3A is a schematic plan view illustrating still another form of the lower collector plate in the energy storage device to which the embodiment is applied; and

FIG. 3B is a schematic plan view illustrating still another form of the adhesive layer in the energy storage device to which the embodiment is applied.

### DETAILED DESCRIPTION OF EMBODIMENTS

Hereinafter, preferred embodiments of the present disclosure will be described in detail with reference to the accompanying drawings. In the drawings, the same signs denote the same parts.

### Basic Configuration of Energy Storage Device

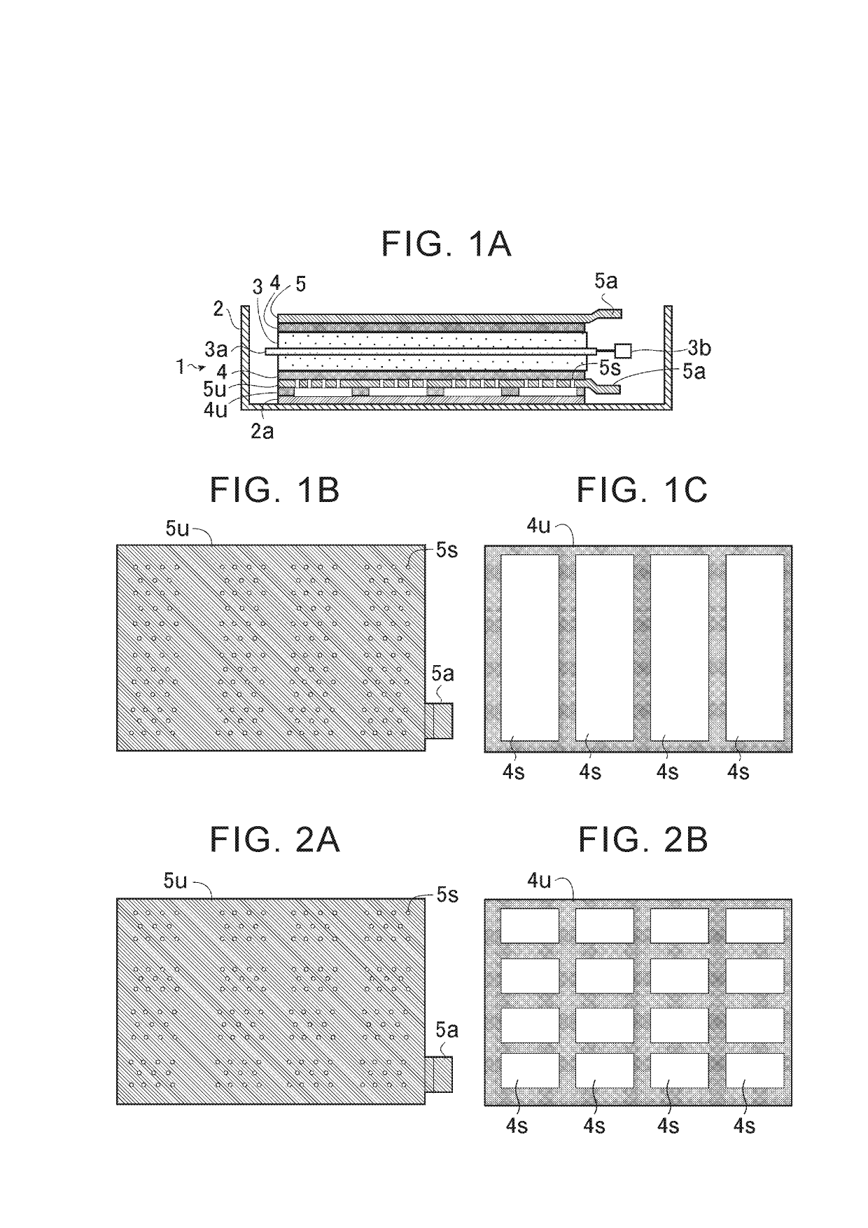

Referring to FIG. 1A, the configuration of the present embodiment may be applied to an energy storage device 1. In the energy storage device 1, a battery module 3, formed by sealing a liquid-electrolyte secondary battery such as a lithium-ion secondary battery in a laminate enclosure, is placed on the inner bottom surface of a tub-shaped battery pack 2 serving as an outer housing. More specifically, the battery module 3 may be of a standard configuration in which a stacked structure is housed and sealed within a laminate enclosure. In the stacked structure, a cathode layer and an anode layer are disposed facing each other across a separator with the space between the cathode and anode layers filled with an electrolyte solution. The cathode and anode layers are formed by coating a cathode foil and an anode foil with cathode and anode active material layers, respectively. The cathode layer, the anode layer, the separator, and the electrolyte solution may be of types commonly used in the art. The stacked structure is typically sealed in the laminate enclosure in the following manner. A laminate material is formed into a shallow, tray-like upper portion protruding upward and a shallow, tray-like lower portion protruding downward. The stacked structure in the form of a thin plate is interposed between the upper and lower portions and received therein, and the peripheral edges of the upper and lower portions are bonded and heat-sealed together, thereby sealing the laminate enclosure against leakage of the electrolyte solution from within the stacked structure. The laminate material forming the laminate enclosure may be a thin laminate film commonly used in the art, such as an aluminum foil with resin layers laminated on both sides. In central regions of the laminate enclosure that correspond to the top and bottom surfaces of the battery module 3, conductive foils are exposed. Collector plates 5, 5u, each having a terminal 5a for external electrical connection, are bonded to the respective exposed conductive foils on the top and bottom surfaces of the laminate enclosure via a conductive adhesive layer 4. Within the battery module 3, the stacked structure may include a plurality of battery cells, each including a cathode layer, a separator, and an anode layer, stacked and connected in series. In that case, voltage monitor terminals 3b for monitoring the voltages of the respective cells may be provided separately from the terminals 5a. The battery module 3, with the collector plates 5 bonded thereto, is secured onto a support base 2a provided on the bottom surface of the battery pack 2, via an additional adhesive layer 4u applied to the underside of the lower collector plate 5u. The terminals 5a attached to the respective collector plates 5, 5u are connected to external leads (not shown). Charging and discharging of the battery are performed through these leads.

### Configuration for Electrolyte Solution Leakage

In the battery module 3 of the energy storage device 1 configured as described above, the stacked structure that constitutes the battery is sealed within the laminate enclosure. Therefore, the electrolyte solution should not leak from the battery module 3. However, if the energy storage device 1 is subjected to mechanical shock, the heat-sealed portion 3a of the laminate enclosure of the battery module 3 may separate or other portions may rupture. In such a case, the electrolyte solution may leak from the laminate enclosure to the outside of the battery module 3, and if the electrolyte solution comes into contact with the terminals 5a, an electrical short-circuit may occur. Accordingly, in the present embodiment, a configuration is provided to suppress electrical short-circuiting due to such leakage of the electrolyte solution.

Specifically, as shown in FIGS. 1A and 1B, through holes 5s permitting passage of liquid are formed in the lower collector plate 5u of the battery module 3. In the adhesive layer 4u on the underside of the lower collector plate 5u, a liquid reservoir 4s is provided in a region below the through holes 5s. The liquid reservoir 4s may be in the form of a recess. The liquid reservoir 4s may be formed by leaving that region uncoated with adhesive and applying adhesive around the region. With this configuration, if the laminate enclosure of the battery module 3 ruptures or its heat-sealed portion separates and the electrolyte solution leaks out, the electrolyte solution passes through the through-holes 5s in the lower collector plate 5u and flows into the liquid reservoir 4s in the adhesive layer 4u. Immersion of the terminals 5a of the collector plates 5, 5u in the electrolyte can thus be suppressed.

The through holes 5s in the lower collector plate 5u and the liquid reservoir 4s in the lower adhesive layer 4u may be provided in various configurations. As shown in FIGS. 1B and 1C, in the adhesive layer 4u, the adhesive may be applied in a stripe pattern, with liquid reservoirs 4s formed in the respective regions between the stripes and through holes 5s provided in the corresponding regions of the collector plate 5u. As shown in FIGS. 2A and 2B, in the adhesive layer 4u, the adhesive may alternatively be applied in a grid pattern, with liquid reservoirs 4s formed in the respective regions bounded by the grid lines and through holes 5s provided in the corresponding regions of the collector plate 5u. Applying the adhesive in a grid pattern achieves higher bonding strength of the adhesive layer 4u, whereas applying the adhesive in a stripe pattern reduces adhesive consumption.

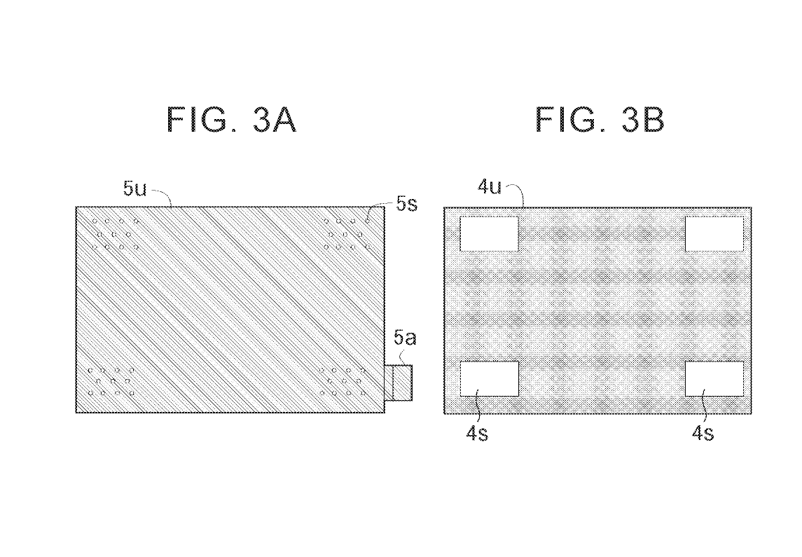

Leakage of the electrolyte solution tends to occur at the four corners of the battery module 3. Accordingly, as shown in FIGS. 3A and 3B, the through holes 5s and the liquid reservoirs 4s may be formed, with appropriate dimensions, in regions below the four corners of the battery module 3.

As described above, according to the present embodiment, in an energy storage device in which a liquid-electrolyte battery module as described above is housed in a battery pack, a liquid reservoir is formed in an adhesive layer provided on the outside of the battery module. Accordingly, when electrolyte solution leaks from the laminate enclosure of the battery module, the electrolyte solution flows into the liquid reservoir. This suppresses contact of the cathode and anode terminals or the voltage monitor terminals with the electrolyte solution, thereby suppressing electrical short-circuiting.

While the disclosure has been described in connection with the embodiments, numerous modifications and variations will be readily apparent to those skilled in the art. It is therefore to be understood that the present disclosure is not limited to the embodiments illustrated above and may be applied to various devices without departing from the spirit and scope of the disclosure.

What is claimed is:

1. An energy storage device comprising:
a battery module in which a stacked structure is housed and sealed within a laminate enclosure and the laminate enclosure is held between a pair of collector plates, the stacked structure including a cathode layer and an anode layer disposed facing each other across a separator with a space between the cathode layer and the anode layer filled with an electrolyte solution, each of the collector plates including a terminal, and the terminals of the collector plates being electrically connected to the cathode layer and the anode layer, respectively, and electrically connected to outside; and
a battery pack that is an outer housing in which the battery module is installed on a bottom surface of the outer housing via an adhesive layer,
wherein a lower one of the collector plates of the battery module that faces the adhesive layer has a through hole, and the adhesive layer includes a liquid reservoir configured to receive liquid passing through the through hole.

2. The energy storage device according to claim 1, wherein the adhesive layer includes a region not coated with adhesive, and the region serves as the liquid reservoir.

3. The energy storage device according to claim 1, wherein the through hole and the liquid reservoir are provided below four corners of the battery module.

4. The energy storage device according to claim 1, wherein, in the adhesive layer, adhesive is provided in a grid pattern on an underside of the lower one of the collector plates of the battery module, and a region not coated with the adhesive serves as the liquid reservoir.

5. The energy storage device according to claim 1, wherein, in the adhesive layer, adhesive is provided in a stripe pattern on an underside of the lower one of the collector plates of the battery module, and a region not coated with the adhesive serves as the liquid reservoir.
